(19) United States
(12) Patent Application Publication
(10) Pub. No.: US 2013/0280520 A1
(43) Pub. Date: Oct. 24, 2013

(54) PHOSPHOR CERAMICS AND METHODS OF MAKING THE SAME

(71) Applicant: NITTO DENKO CORPORATION, Osaka (JP)

(72) Inventors: Guang Pan, Carlsbad, CA (US); Jiadong Zhou, San Diego, CA (US); Hironaka Fujii, Carlsbad, CA (US); Bin Zhang, San Diego, CA (US); Amane Mochizuki, Carlsbad, CA (US)

(21) Appl. No.: 13/865,956

(22) Filed: Apr. 18, 2013

Related U.S. Application Data
(60) Provisional application No. 61/625,796, filed on Apr. 18, 2012.

(51) Int. Cl. C09K 11/77

(52) U.S. Cl. CPC C09K 11/7792
USPC 428/331; 252/301.4 F; 264/21; 428/446

(57) ABSTRACT

Electric sintering of precursor materials to prepare phosphor ceramics is described herein. The phosphor ceramics prepared by electric sintering may be incorporated into devices such as light-emitting devices, lasers, or used for other purposes.

### CROSS-REFERENCE TO RELATED APPLICATIONS

This application claims the benefit of U.S. Provisional Patent Application No. 61/625,796, filed Apr. 18, 2012, which is incorporated by reference herein in its entirety.

### BACKGROUND

1. Field

Embodiments described herein relate generally to ceramic materials, such as phosphor ceramics prepared by applying a pulse electric current.

2. Description of the Related Art

Use of light-emitting diodes (LED) for lighting has attracted more attention in recent years as an energy saving light source. White light can be generated using a combination of an LED with a blue emission line with phosphors with a yellow or yellow green emission line. For example, cerium doped yttrium aluminum garnet Y₃Al₅O₁₂:Ce³⁺ may be used in such applications.

Compared with phosphor particles in a polymer matrix, ceramic inorganic materials have a higher thermal conductivity and polycrystalline microstructure. Inorganic ceramic materials appear to be more stable in high temperature and moisture environments. Phosphor materials in a dense ceramic form can be an alternative to conventional particulate matrix applications. Such a ceramic made of consolidated phosphor powders can be prepared by conventional sintering processes.

In general, ceramics can be manufactured by various processes such as vacuum sintering, controlled atmosphere sintering, uniaxial hot pressing, hot isostatic pressing (HIP) and so on. In order to get densified ceramics, the application of relatively high temperatures and/or pressures may be necessary. Useful phosphors include oxides, fluorides, oxyfluorides sulfides, oxisulfides, nitrides, oxynitride etc. Among them, some systems are vulnerable to high temperature due to the decomposition of the phosphor, and are thus difficult to sinter.

Some drawbacks of conventional sintering processes include long cycle time and slow heating and cooling rates. In addition, for some thermally unstable phosphor powders, prolonged exposure to high temperature can cause the decomposition or degradation of the powder, leading to complete or partial loss of luminescence.

### SUMMARY

Precursor compositions for inorganic ceramics may be sintered by applying an electric current, such as a pulse electric current, to the precursor compositions. This sintering method may be used to produce a dense phosphor ceramic. The sintering may be carried out under pressure, such as a pressure of about 1 MPa to about 500 MPa. Sintering temperatures may also be lower than those used for conventional sintering processes.

Some methods of preparing dense phosphor ceramics comprise: heating a multi-elemental composition to sinter the composition by applying a pulse electric current to the composition at a pressure between about 1 MPa to about 500 MPa; wherein the method produces a dense phosphor ceramic.

Some embodiments include a method of preparing a dense phosphor ceramic, comprising: heating a multi-elemental composition to sinter the composition by applying a pulse electric potential to the composition at a pressure of about 1 MPa to about 500 MPa; wherein the method produces a dense phosphor ceramic.

Some embodiments include a method comprising providing a multi-elemental composition; applying a pulse electric current effective to cause heating of the multi-elemental composition to a hold temperature; and applying to the multi-elemental composition a pressure of about 1 MPa to about 500 MPa and a temperature below conventional sintering process temperatures.

Some embodiments include an emissive layer comprising a ceramic made as described herein. An embodiment provides a lighting device comprising the emissive layer described herein.

Some embodiments include a method of preparing a dense phosphor ceramic, comprising: heating a multi-elemental composition to sinter the composition by applying a pulse electric current to the composition at a pressure of about 1 MPa to about 500 MPa, wherein the multi-elemental composition comprises: a garnet or a garnet precursor; and a nitride or a nitride precursor; wherein the method produces a dense phosphor ceramic.

These and other embodiments are described in greater detail below.

### BRIEF DESCRIPTION OF THE DRAWINGS

FIG. 1 is a diagram of an example of a press for an electric sintering process.

FIG. 2 is a processing flowchart for preparing some embodiments of phosphor ceramics from powder precursors using electric sintering.

FIG. 3 is a processing flowchart for preparing some embodiments of phosphor ceramics from green sheet laminates using electric sintering.

FIG. 4 depicts a configuration used an example of multi-piece sintering of phosphor ceramics by an electric sintering process.

FIG. 5 depicts a configuration for co-sintering two different phosphor powders or pre-sintered ceramics plates.

FIG. 6 shows an example of one way that a phosphor ceramic may be integrated into a light-emitting device (LED).

FIG. 7 is a photoluminescent spectrum of the YAG:Ce³⁺ phosphor ceramic of Example 1.

FIG. 8 is a photoluminescence spectrum of an SPS-sintered phosphor bulk comprising commercial nitride red phosphor.

FIG. 9 depicts an example of integration of phosphor ceramics for warm white light.

### DETAILED DESCRIPTION

Generally, a multi-elemental composition is heated to sinter the mixture by applying a pulse electric potential or pulse electric current (referred to collectively herein as “electric sintering”) to the composition to provide a dense phosphor ceramic. This may allow fast heating or cooling rates, shorter sintering times, and/or shorter sintering temperatures. Since electric sintering may be at a lower temperature than conventional sintering, it may be used to sinter materials that are unstable at conventional sintering temperatures. Electric sintering may also provide a homogeneous and stable emissive phosphor in comparison with conventional phosphor powder suspended polymer matrices. Electric sintering may also allow the integration of more than one kind of phosphor, e.g., nitrides and/or oxides, into ceramic phosphor compacts having improved Color Rendering Index at adjusted color temperatures. Furthermore, electric sintering may provide a way to consolidate phosphors which are thermally instable. Electric sintering may be carried out while the composition is under pressure. In some embodiments, phosphor powders can be consolidated to fully dense or close to fully dense ceramics by electric sintering at lower temperatures for a very short duration, and in a vacuum or an adjusted atmosphere.

In some embodiments, a multi-elemental composition may be sintered by Spark Plasma Sintering (SPS). Unlike a conventional hot press sintering process, SPS does not employ a heating element or conventional thermal insulation of the vessel. Instead, a special power supply system feeds high current into water-cooled machine rams, which act as electrodes, simultaneously feeding the high current directly through the pressing tool and the material the pressing tool contains. This construction leads to a homogeneous volume heating of the pressing tool as well as the powder it contains by means of Joule heat. This results in a favorable sintering behavior with less grain growth and suppressed powder decomposition. By using SPS techniques, phosphor powders may be consolidated in a short time, on the order of minutes instead of hours for conventional sintering procedures. In some embodiments, the sintering may be accomplished by heating the material for about 1 minute to about 60 minutes, about 10 minutes to about 40 minutes, about 20 minutes to about 30 minutes, about 25 minutes, or 24 minutes. SPS techniques may lead to smaller generated grain size in the resultant products, generally on the order of nanometers.

Any suitable pressure may be applied during the sintering process. In some embodiments, sintering may be carried out at a pressure of about 1 MPa to about 500 MPa, about 1 MPa to about 100 MPa, about 5 MPa to about 80 MPa, about 15 MPa to about 75 MPa, about 35 MPa to about 55 MPa, about 0.01 MPa to about 300 MPa, about 25 MPa to 200 MPa, about 30 MPa to about 100 MPa, about 30 MPa to about 50 MPa, about 40 MPa, or any pressure in a range bounded by, or between, any of these values. Pressure may be applied by a graphite press, which is commonly used in the art. For graphite presses it may be desirable to apply pressures that are about 40 MPa or less. For some presses employing alternative materials, higher pressures than 40 MPa may be used.

An electric potential, such as a pulse electric potential, may be applied to a multi-element composition in order to sinter the material. The electric potential applied to a multi-element composition can cause a current, such as a pulse electric current, to flow through the multi-element composition and/or through material of a press or other sintering device containing the multi-element composition. The current may heat the multi-element composition to sinter the composition. The time and nature of the electric current may vary. In some embodiments, a pulse electric current may be applied. The time of a pulse current may vary. For example, a pulse may be about 0.5 milliseconds (ms) to about 10 ms, about 1 ms to about 5 ms, or about 3 ms, about 3.3 ms, in length, or may be any length of time in a range bounded by, or between, any of these values. A rise time, or period of time in which current increases, for an electric pulse may vary. In some embodiments, an electric pulse may have a rise time of about half, or slightly less than half, that of the pulse time, such as about 30% to about 50%, about 40% to about 49%, or about 45%, of the length of the pulse. For example, a 3.3 ms pulse may have a rise time of about 1.5 ms. In some embodiments, a pulse electric current may have a pattern. For example, 12 pulses of 3.3 ms duration with a rise time of about 1.5 ms, may be followed by 2 pulses of 3.3 ms non electrified pulses.

Any suitable level of electric current may be applied as a pulse. In some embodiments, a suitable electric current may be between about 250 A to about 750 A, about 400 A to about 600 A, or about 500 A.

Initially, if a multi-element composition is a powder with many voids, or is and insulator, the electric current may run through the sintering press material and die (or the material of any sintering device containing the material) and thus externally heat the multi-element composition by heat transfer from the sintering device to the composition. A multi-element composition having fewer and/or smaller voids (either because a more compact composition is initially used, or because pressure applied to a multi-element composition has reduced the number and/or size of the voids), or a multi-element composition that is electrically conductive may have the electric current run through the composition. Thus, a multi-element composition may be heated by electric current flowing through the composition itself. As a result, a multi-element composition may by internally heated by the current through the composition in addition to any external heating of the composition that may occur, either by current flow through the press, or other sources of external heat. In some embodiments, internal and/or external heating that results from applying an electric potential to the multi-element composition that results in an electric current can cause a temperature rise rate of about 50° C./min to about 600° C./min; 50° C. to about 200° C./min; about 50° C./min to about 150° C./min; about 80° C./min to about 120° C./min; about 50° C./min to about 100° C./min; or about 100° C./min. In some embodiments, the temperature may be increased for about one minute to about 60 minutes, about 5 minutes to about 30 minutes, about 10 minutes to about 20 minutes, or about 14 minutes before holding the multielement composition at a relatively constant temperature.

A multi-element composition may be heated by electric current to a holding temperature (or temperature range), and then held at the holding temperature to continue the sintering process. In some embodiments, the holding temperature (or temperature range) may be below conventional sintering process temperatures. For example, the holding temperature can be a temperature such as about 1000° C. to about 1800° C., about 1200° C. to about 1600° C., about 1300° C. to about 1550° C., about 1400° C., or any temperature in a range bounded by, or between, any of these values. A multi-element composition may be held at the holding temperature for any suitable holding time. In some embodiments, the holding time may be about 1 minute to about 10 hours, about 1 minute to about 2 hours, about 1 minute to about 1 hour, about 1 minute to about 30 minutes, about 5 minutes to about 30 minutes, about 10 minutes, or any amount of time in a range bounded by, or between, any of these values.

Pressure can be applied at a variable rate, which is consistent with a heating ramp, or faster or slower than a heating ramp. In some embodiments, the maximum pressure can be applied at the beginning of heating and held at that pressure until the desired temperature has been applied for the requisite time or until the target temperature has been achieved.

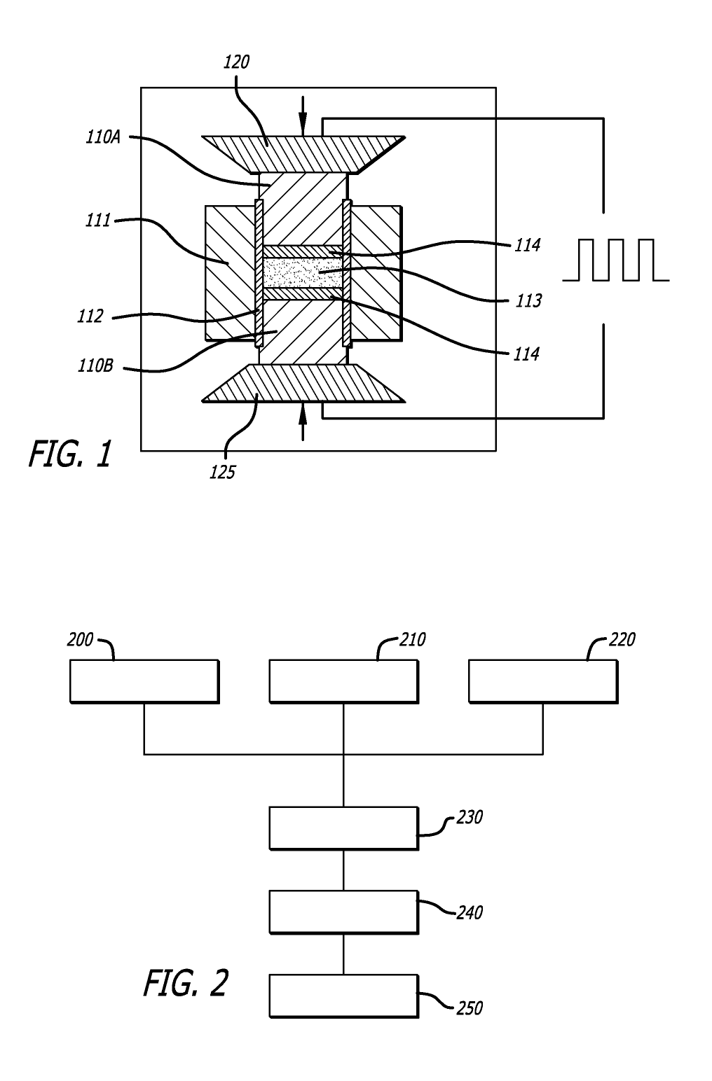

FIG. 1 depicts an assembly that may be used for a pulsed electric current sintering. A multi-elemental composition, such as oxide phosphor powder 113, can be loaded into a die, such as graphite die 111, and sandwiched with two punches, such as graphite punches 110A and 1108, separated from the oxide phosphor powders 113 by spacers, such as molybdenum or graphite spacers 114. The assembly of phosphor powders can be set in between two rams, such as graphite rams 120 and 125, which also act as electrodes for pulse electric current flowing through the multi-elemental composition. The setup can be enclosed in a chamber which can be operating in vacuum or other desired atmospheric conditions or environments. DC pulse electric voltage is applied to the electrodes/rams at adjustable on-off time. In some embodiments 12 pulses are applied on, and 2 pulses are then applied having the electric current off. For example, a series of twelve pulses of 500 A, 3.3 ms in duration with a rise of 1.5 ms can be applied, followed by two non-electrified pulses. Uniaxial pressure can be applied to the powders though the rams and punches during heating.

After sintering, a phosphor ceramic may be annealed by heating the phosphor and holding for a period of time. For example, a ceramic phosphor may be annealed by holding the ceramic phosphor at about 1000° C. to about 2000° C., about 1200° C. to about 1600° C., about 1200° C., or about 1400° C. The ceramic phosphor may be held for as long as desired to obtain the desired annealing effect, such as about 10 minutes to about 10 hours, about 30 minutes to about 4 hours, or about 2 hours.

For some phosphor ceramics, a second annealing may be done under reduced pressure or in a vacuum. For example, a phosphor ceramic may be annealed at a pressure of about 0.001 Torr to about 50 Torr, about 0.01 Torr, or about 20 Torr. Temperatures for a reduced pressure annealing may depend upon the desired effect. In some embodiments, a second annealing may be at a temperature of about 1000° C. to about 2000° C., about 1200° C. to about 1600° C., or about 1400° C., and at a reduced pressure. A second annealing may be carried out for as long as desired to obtain the effect sought, such as about 10 minutes to about 10 hours, about 30 minutes to about 4 hours, or about 2 hours.

A multi-elemental composition may include any composition comprising at least two different atomic elements.

A multi-elemental composition may comprise a bi-elemental oxide, including a compound containing at least two different atomic elements, wherein at least one of the two different atomic elements includes oxygen.

A multi-elemental composition may comprise a bi-elemental non-oxide, including a compound containing at least two different atomic elements, wherein the two different elements do not include oxygen.

In some embodiments, a multi-elemental composition can be a precursor host material. A host material includes any material that can have one or more atoms in a solid structure replaced by a relatively small amount of a dopant. The dopant can take a position in the solid structure occupied by the atoms it replaces from the host. In some embodiments, the host material may be a powder comprising a single inorganic chemical compound, e.g., YAG powder as compared to yttria and alumina. In either of the above options, the materials can have an average grain diameter of about 0.1 μm to about 200 μm, about 1 μm to about 150 μm, or about 0.1 μm to about 20 μm.

In some embodiments, a multi-elemental composition can comprise phosphor powders. Phosphor powders can include, but are not limited, to oxides including silicate, phosphate, aluminate, borate, tungstate, vanatate, titanate, molybdate or combinations of those oxides. Phosphor powders can also include sulfides, oxysulfides, oxyfluorides, nitrides, carbides, nitridobarates, chlorides, phosphor glass or combinations thereof.

A multi-elemental composition may include a host-dopant material, such as a material that is primarily a single solid state compound, or host material, having a small amount of one or more atoms in the host structure substituted by one or more non-host atoms, or dopant atoms. In some embodiments, the multi-elemental composition can comprise a garnet, a garnet precursor, a nitride, or a nitride precursor. In some embodiments the multi-elemental composition can further comprise a dopant or a dopant precursor. A dopant precursor is a component that contains one or more atoms that, when added to a multi-elemental composition, become atoms of a dopant.

In some embodiments, the multi-elemental composition can include a garnet. As used herein, a “garnet” includes any material that would be identified as a garnet by a person of ordinary skill in the art, and any material identified as a garnet herein. In some embodiments, the term “garnet” refers to the tertiary structure of an inorganic compound, such as a mixed metal oxide.

In some embodiments, the garnet may be composed of oxygen and at least two different elements independently selected from groups II, III, IV, V, VI, VII, VIII, or Lanthanide metals. For example, the garnet may be composed of oxygen and a combination of two or more of the following elements: Ca, Si, Fe, Eu, Ce, Gd, Tb, Lu, Nd, Y, La, In, Al, and Ga.

In some embodiments, a synthetic garnet may be described as A₃D₂(EO₄)₃, wherein A, D, and E are elements selected from group II, III, IV, V, VI, VII, VIII elements, and Lanthanide metals. A, D, and E may either represent a single element, or they may represent a primary element that represents the majority of A, D, or E, and a small amount of one or more dopant elements also selected from group II, III, IV, V, VI, VII, VIII elements, and Lanthanide metals. Thus, the formula may be expanded to:

(primary A+dopants)₃(primary D+dopants)₂[(primary E+dopants)O₄]₃.

In a garnet particle, the primary element or dopant element atom of A (e.g., Y³⁺) may be in a dodecahedral coordination site or may be coordinated by eight oxygen atoms in an irregular cube. Additionally, the primary element or dopant element atom of D (e.g., Al³⁺, Fe³⁺, etc.) may be in an octahedral site. Finally, the primary element or dopant element atom of E (e.g., Al³⁺, Fe³⁺, etc.) may be in a tetrahedral site.

In some embodiments, a garnet can crystallize in a cubic system, wherein the three axes are of substantially equal lengths and perpendicular to each other. In these embodiments, this physical characteristic may contribute to the transparency or other chemical or physical characteristics of the resulting material. In some embodiments, the garnet may be yttrium iron garnet (YIG), which may be represented by the formula Y₃Fe₂(FeO₄)₃ or (Y₃Fe₅O₁₂). In YIG, the five iron(III) ions may occupy two octahedral and three tetrahedral sites, with the yttrium(III) ions coordinated by eight oxygen ions in an irregular cube. In YIG, the iron ions in the two coordination sites may exhibit different spins, which may result in magnetic behavior. By substituting specific sites with rare earth elements, for example, interesting magnetic properties may be obtained.

Some embodiments comprise metal oxide garnets, such as Y₃Al₅O₁₂ (YAG) or Gd₃Ga₅O₁₂ (GGG), which may have desired optical characteristics such as transparency or translucency. In these embodiments, the dodecahedral site can be partially doped or completely substituted with other rare-earth cations for applications such as phosphor powders for electroluminescent devices. In some embodiments, specific sites are substituted with rare earth elements, such as cerium. In some embodiments, doping with rare earth elements or other dopants may be useful to tune properties such as optical properties. For example, some doped compounds can luminesce upon the application of electromagnetic energy. In phosphor applications, some embodiments are represented by the formula (A₁₋ₓREₓ)₃D₅O₁₂, wherein A and D are divalent, trivalent, quadrivalent or pentavalent elements; A may be selected from, for example, Y, Gd, La, Lu, Yb, Tb, Sc, Ca, Mg, Sr, Ba, Mn and combinations thereof; D may be selected from, for example, Al, Ga, In, Mo, Fe, Si, P, V and combinations thereof; and RE may be rare earth metal or a transition element selected from, for example, Ce, Eu, Tb, Nd, Pr, Dy, Ho, Sm, Er, Cr, Ni, and combinations thereof. This compound may be a cubic material having useful optical characteristics such as transparency, translucency, or emission of a desired color.

In some embodiments, a garnet may comprise yttrium aluminum garnet, Y₃Al₅O₁₂ (YAG). In some embodiments, YAG may be doped with neodymium (Nd³⁺). YAG prepared as disclosed herein may be useful as the lasing medium in lasers. Embodiments for laser uses may include YAG doped with neodymium and chromium (Nd:Cr:YAG or Nd/Cr:YAG); erbium-doped YAG (Er:YAG), ytterbium-doped YAG (Yb:YAG); neodymium-cerium double-doped YAG (Nd:Ce:YAG, or Nd,Ce:YAG); holmium-chromium-thulium triple-doped YAG (Ho:Cr:Tm:YAG, or Ho,Cr,Tm:YAG); thulium-doped YAG (Tm:YAG); and chromium (IV)-doped YAG (Cr:YAG). In some embodiments, YAG may be doped with cerium (Ce³⁺). Cerium doped YAGs may be useful as a phosphors in light emitting devices such as light emitting diodes and cathode ray tubes. Other embodiments include dysprosium-doped YAG (Dy:YAG); and terbium-doped YAG (Tb:YAG), which are also useful as phosphors in light emitting devices.

A garnet precursor includes any composition that can be heated to obtain a garnet. In some embodiments, a garnet precursor comprises an oxide of yttrium, an oxide of aluminum, an oxide of gadolinium, an oxide of lutetium, an oxide of gallium, an oxide of terbium, or a combination thereof.

In some embodiments, the nitride host material can be a material having a quaternary host material structure represented by a general formula M-A-B-N:Z. Such a structure may increase the emission efficiency of a phosphor. In some embodiments, M is a divalent element, A is a trivalent element, B is a tetravalent element, N is nitrogen, and Z is a dopant/activator in the host material.

M may be Mg, Be, Ca, Sr, Ba, Zn, Cd, Hg, or a combination thereof. A may be B (boron), Al, Ga, In, Ti, Y, Sc, P, As, Sb, Bi, or a combination thereof. B may be C, Si, Ge, Sn, Ni, Hf, Mo, W, Cr, Pb, Zr, or a combination thereof. Z may be one or more rare-earth elements, one or more transition metal elements, or a combination thereof.

In the nitride material, a mole ratio Z/(M+Z) of the element M and the dopant element Z may be about 0.0001 to about 0.5. When the mol ratio Z/(M+Z) of the element M and the activator element Z is in that range, it may be possible to avoid decrease of emission efficiency due to concentration quenching caused by an excessive content of the activator. A mole ratio in that range may also help to avoid a decrease of emission efficiency due to an excessively small amount of light emission contributing atoms caused by an excessively small content of the activator. Depending on the type of the activating element Z to be added, the effect of the percentage of Z/(M+Z) on emission efficiency may vary. In some embodiments, a Z/(M+Z) mol ratio in a range from 0.0005 to 0.1 may provide improved emission.

For a composition wherein M is Mg, Ca, Sr, Ba, Zn, or a combination thereof, raw materials can be easily obtained and the environmental load is low. Thus, such a composition may be preferred.

For a composition wherein M is Ca, A is Al, B is Si, and Z is Eu in a material, raw materials can be easily obtained and the environmental load is low. Additionally, the emission wavelength of a phosphor having such a composition is in the red range. A red based phosphor may be capable of producing warm white light with a high Color Rendering Index (CRI) at adjusted color temperature when combined with blue LED and yellow phosphors. Thus, such a composition may be preferred.

A nitride precursor includes any composition that can be heated to obtain a nitride. Some useful nitride precursors can include Ca₃N₂ (such as Ca₃N₂ that is at least 2N), AlN (such AlN as that is at least 3N), and/or Si₃N₄ (such as Si₃N₄ that is at least 3N). The term 2N refers to a purity of at least 99% pure. The term 3N refers to a purity of at least 99.9% pure.

In some embodiments, a multi-elemental composition can further include a dopant precursor. In some embodiments, the dopant can be a rare earth compound or a transition metal. In some embodiments, the dopants can be selected from Ce³⁺ and or Eu²⁺. Suitable dopant precursors include compounds or materials that include Ce, Eu, Tm, Pr, or Cr atoms or ions. Examples include, but are not limited to, CeO₂, Ce[NO₃]₃.6H₂O, Ce₂O₃)₃, and/or EuN. Other suitable dopant precursors include the respective metal oxide of the desired dopant atom or ion, e.g., oxides of Tm, Pr, and or Cr.

In some embodiments, the dense phosphor ceramic comprises a garnet having a formula (Y₁₋ₓCeₓ)₃Al₅O₁₂, wherein x is about 0 to about 0.05, about 0.001 to about 0.01, about 0.005 to about 0.02, about 0.008 to about 0.012, about 0.009 to about 0.011, about 0.003 to about 0.007, about 0.004 to about 0.006, or about 0.005.

In some embodiments, the dense phosphor ceramic comprises CaAlSiN₃:Eu²⁺, wherein the Eu²⁺ is about 0.001 atom % to about 5 atom %, about 0.001 atom % to about 0.5 atom %, about 0.5 atom % to about 1 atom %, about one atom % to about 2 atom %, about 2 atom % to about 3 atom %, about 3 atom % to about 4 atom %, or about 4 atom % to about 5 atom %, based upon the number of Ca atoms.

In some embodiments, a multi-elemental composition may be a pre-form of a phosphor powder. A pre-form may be made by compacting a phosphor powder at uniaxial or isotropic pressure.

Sintering a multi-elemental composition using an electric current may produce a ceramic material as a product, such as a dense phosphor ceramic. In some embodiments, such a ceramic material may have a theoretic density, meaning the density of the material as compared to a solid of the same ceramic material with no voids, of at least 70%, at least 75%, at least 80%, at least 85%, at least 90%, at least 95%, at least 97%, or at least 99%, and may approach 100%. Some YAG ceramic products may have a density of about 4.3 g/mL to about 4.6 g/mL, about 4.4 g/mL to about 4.55 g/mL, or about 4.51 g/mL.

In some embodiments, the electrically sintered ceramic material has a resultant grain size of about 0.1 μm to about 20 μm; about 0.5 μm to about 15 μm; about 1 μm to about 10 μm; or about 1 μm to about 5 μm.

In some embodiments, electric sintering a complete host or precursor material may be done while the material is on a sintered ceramic plate. The term complete host material refers to a host material with the complete stoichiometric formula, e.g., complete YAG powder refers to Y₃Al₅O₁₂ powder, or a complete nitride powder could be CaAlSiN₃. Precursor materials for YAG could include Al₂O₃, Y₂O₃, etc. Precursors for nitride powder could include Ca₃N₂, AlN, Si₃N₄, etc.

Some embodiments include a ceramic plate prepared by electric sintering. In some embodiments, a sintered ceramic plate can comprise a plurality of sintered plates laminated to one another.

In some embodiments, a ceramic compact is provided comprising a first layer comprising garnet material and a second layer comprising a nitride material. In some embodiments, a ceramic compact comprises a garnet material and a nitride material in a single layer. In some embodiments, the garnet material can be a yttrium garnet. In some embodiments, the nitride material can be CaAlSiN₃.

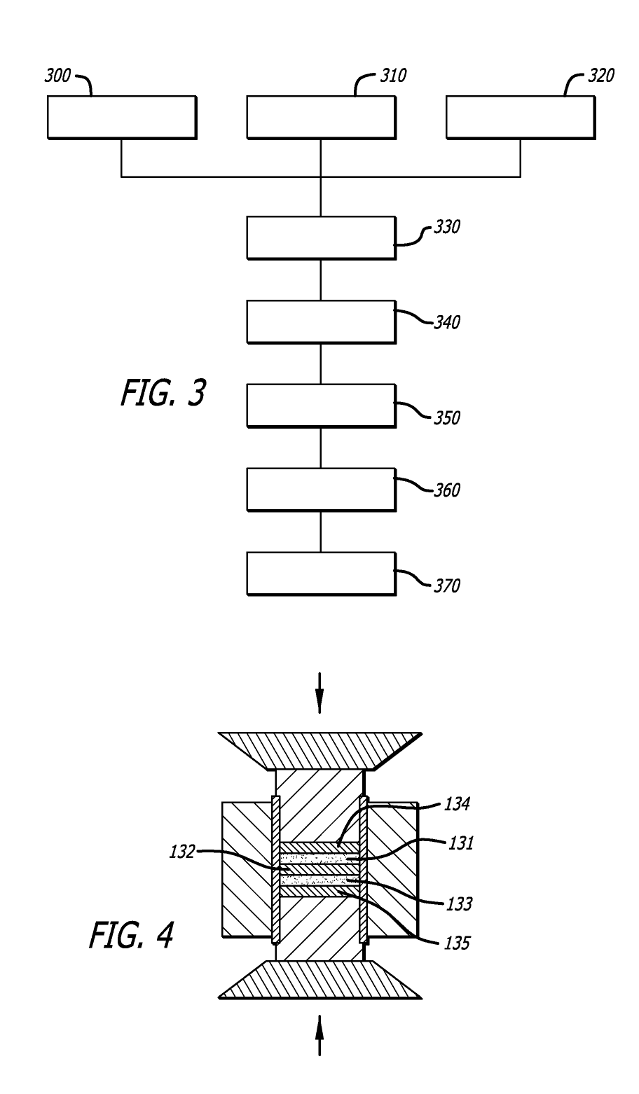

FIGS. 2 and 3 show examples of processes for sintering phosphor ceramics, e.g., garnet and/or nitride host materials, by electric sintering.

In some embodiments, phosphor ceramics may be formed by reaction of precursors and consolidation of reaction product by treating the precursors with electric sintering conditions. FIG. 2 shows an example of such a process. Precursor powders, e.g. first precursor 200 and second precursor 210, may be mixed with optional sintering aids 220 by ball milling 230. The milled precursor powder may then be treated by electric sintering conditions 240 and annealing 250.

Ball milling may be carried out in a planetary ball milling machine for reducing precursor size, homogeneous mixing of precursors and increasing reactivity by the defects formed on precursor powders. Useful ball milling rates may be in a range of about 500 rpm to about 4000 rpm, about 1000 rpm to about 2000 rpm, or about 1500 rpm. Ball milling may be carried out for a period of time that is adequate to provide the desired effect. For example, ball milling may be carried out for about 0.5 hrs to about 100 hrs, about 2 hrs to about 50 hrs, or about 24 hrs.

In processes depicted by FIG. 3, precursor materials, such as first precursor 300 and second precursor 310, may be mixed with sintering aids 320. The mixture may be tape cast 330 to form pre-forms of plates. The pre-formed plates are then stacked 340 (lamination). The laminates may comprise green sheets containing one kind of phosphor powder or more than one kind of phosphor powder. The laminates can also consist of more than one kind of green sheet containing phosphor. The resultant laminate can then be heated 350 and held at temperature above 400° C. to burn-out the organic components before electric sintering (debinder) or partially sintered at about 1000° C. to increase mechanical strength of the preform. The pre-laminate is then treated by electric sintering 360 and annealing 370.

In some embodiments, a dense phosphor ceramic may have an internal quantum efficiency (IQE) of at least 70%, at least 75%, at least 80%, at least 85%, at least 90%, at least 95%, at least 97%, or at least 99%.

As shown in FIG. 4, in some embodiments, two or more multi-element compositions 131 and 133, such as phosphor green sheet laminates or phosphor powders, may be separated by graphite or molybdenum spacers 132, 134, and 135 during electric sintering. After sintering, plural phosphor ceramics pieces are obtained.

In some embodiments, a combination of two or more phosphor powders or pre-sintered ceramics plates are co-sintered by electric sintering to obtain a phosphor ceramic with a different emission wavelength than either individual phosphor powder. FIG. 5 shows the configuration for such a process. Phosphor A 120, comprising a first phosphor powder or a first pre-sintered ceramics plate, and phosphor B 121, comprising a second phosphor powder or a second pre-sintered ceramics plate, are sintered together in an electric sintering device such as an SPC press.

In some embodiments, pre-sintered phosphor ceramics plates and phosphor powders are co-sintered by electric sintering, wherein the phosphor powder has a different emission spectrum than the ceramic plate. This may form a consolidated phosphor ceramic that integrates more than one kind of phosphor with different emission peak wavelengths, thus adjusting the color rendering index.

In some embodiments, phosphor ceramics having a dopant concentration gradient may be formed by sintering laminates of plural green sheets by electric current. In these embodiments, each green sheet may contain phosphor powder with a different dopant concentration. Thus, when sintering is complete, a single ceramic having a dopant concentration gradient may be formed from the fusion of the green sheets.

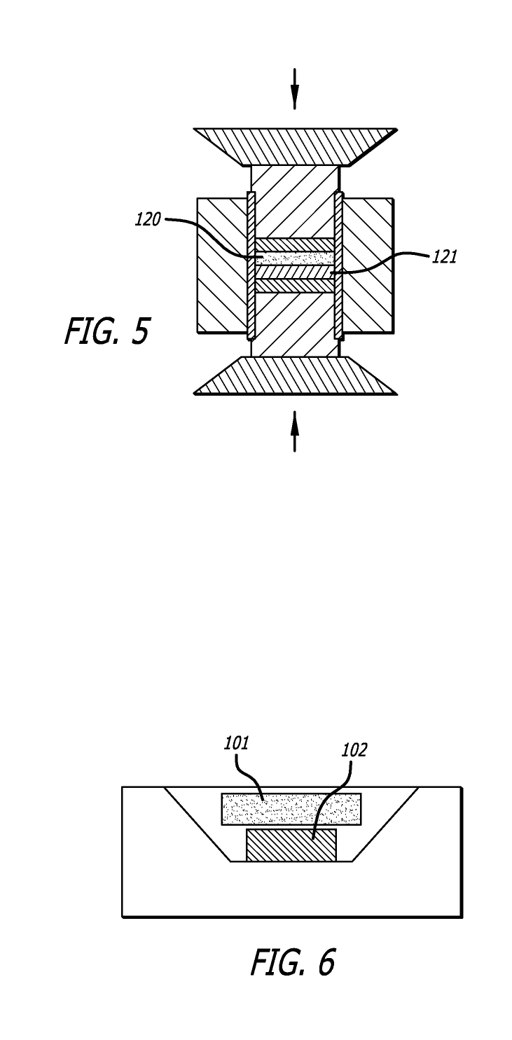

FIG. 6 shows an example of one way that a phosphor ceramic may be integrated into an LED. A phosphor ceramic 101 may be disposed above a light-emitting diode 102 so that light from the LED passes through the phosphor ceramic before leaving the system. Part of the light emitted from the LED may be absorbed by the phosphor ceramic and subsequently converted to light of a lower wavelength by luminescent emission. Thus, the color of light-emitted by the LED may be modified by a phosphor ceramic such as phosphor ceramic 101.

### EXAMPLES

It has been discovered that embodiments of phosphor ceramics described herein can be prepared by Spark Plasma Sintering. The ceramics obtained by this method may be used in light sources of warm white with high CRI. These benefits are further shown by the following examples, which are intended to be illustrative of the embodiments of the disclosure, but are not intended to limit the scope or underlying principles in any way.

### Example 1

### SPS sintered YAG:Ce³⁺ Phosphor Ceramics

Al₂O₃ (42.88 g, Sumitomo Chemical, Osaka/Tokyo, Japan, AKP-3, 99.9%) and 56.71 g Y₂O₃ (Nippon Yttrium Co. Ltd., Tokyo/Fukuoka, Japan 99.9%) were added into 250 mL Al₂O₃ ball mill jar containing 110 g ZrO₂ ball of 3 mm in diameter. After adding 1.0964 g Ce(NO₃)₃.6H₂O (Sigma-Aldrich, 99.9%), 0.5 g TEOS (Tetraethyl Orthosilicate), and 33.3 g ethanol, the ball mill jar was set in a planetary ball milling machine (SFM-1 Desk Top Planetary Ball Miller, MTI Corp) and kept ball milling at 1500 rpm for about 24 hrs to mix the precursor powder. The amount of Ce(NO₃)₃.6H₂O in the precursor mixture was equivalent to a Ce³⁺ content of x=0.01, which corresponds to the formula (Y₁₋ₓCeₓ)₃Al₅O₁₂ of the YAG phase obtained by solid state reaction of the precursor mixture. The precursor powder slurry was transferred to an agate mortar and heated in an oven set at 100° C. for about 2 hours to evaporate off the previously added ethanol. The dried slurry was then placed in a Al₂O₃ crucible then calcinated in a box furnace at ramp of 5° C./min up to 1300° C. and kept at that temperature for about 5 hrs to convert the precursor mixture into YAG:Ce phase. The obtained powder was ground in agate mortar and passed through a 400 mesh sieve with an opening of about 37 μm.

SPS sintering was performed under a vacuum of about 7.5×10⁻² Torr in a Dr Sinter SPS-515S apparatus (Sumitomo Coal Mining Col Ltd.). YAG:Ce³⁺ powder (0.658 g) made as described above was compacted in graphite die with an inner diameter of 13 mm and a wall thickness of 50 mm. The powder was separated from the die by spacers made of graphite foil of about 0.5 mm in thickness. Two graphite cylinder punches with same diameter as the dies were pushed into the graphite die onto the spacer. This assembly was set in vacuum chamber between two high strength graphite plungers, which were kept in contact with the graphite punches at both sides at an initial uniaxial pressure of 2.8 kNf. The graphite plungers also worked as the electrodes during sintering. DC on-off pulse voltage was applied to the electrodes simultaneously. The duration of the pulse was 3.3 ms with a rise time of about 1.5 ms. Electric current increased with rising sintering temperature and reached a maxium of about 508 A. A pyrometer mounted outside close to the window at the chamber was used for monitoring and controlling the temperature during sintering. YAG:Ce³⁺ powder was heated up to about 1400° C. at rate of 100° C./min and kept at 1400° C. for about 10 min with an applied pressure of about 5 kNf corresponding to about 40 MPa at beginning of heating. The applied pressure was then released to the initial uniaxial pressure (2.8 kNf) at the end of temperature holding duration (e.g., about 10 mins).

The sintered sample was then annealed in air at 1400° C. for about 2 hr to burn-out the graphite that appeared to attach to the sample surface during sintering. A second annealing was carried out at low vacuum of about 20 Torr at 1400° C. for about 2 hrs in a tube furnace to cure the oxygen vacancy formed during sintering.

Bulk density of the sintered samples was measured by the method based on Archimedes' principle, i.e. measuring the sample weight in dry condition and in water at 25° C. The bulk density was estimated based on the formula as

Bulk density=(W_{dry}/(W_{dry}−W_{wet}))×ρ_{H2O}

where W_{dry} is the weight of the sample in air, W_{wet} is the weight of the sample in water, and ρ_{H2O} is the density of water at 25° C.

The sample sintered at 1400° C. for 10 min at 40 MPa exhibited a bulk density value of 4.51 g/cm³ with respect to theoretical value of 4.55 g/cm³ for garnet single crystals.

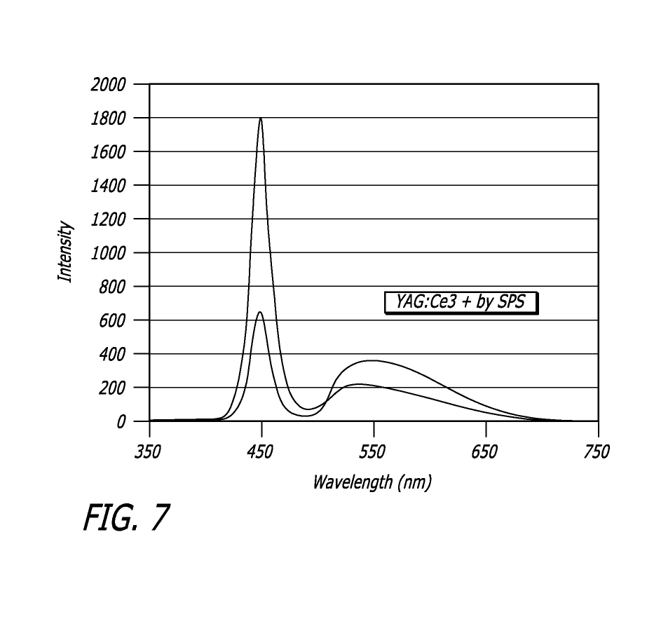

IQE and PL spectra measurements were performed with an Otsuka Electronics MCPD 7000 multi channel photo detector system (Osaka, JPN) together with required optical components such as integrating spheres, light sources, monochromator, optical fibers, and sample holder. The photoluminescence spectrum is shown in FIG. 7. IQE of the sample sintered by SPS gave a value of 84%.

### Example 2

### Nitride Red Phosphor Ceramics

SPS sintering was performed under vacuum about 7.5×10⁻² Torr in Dr Sinter SPS-515S apparatus (Sumitomo Coal Mining Col Ltd.). Commercial nitride red phosphor (Intematix ER 6436) with a broad emission spectra in the wavelength range from 525 nm to 800 nm and peak wavelength at 630 nm was used in SPS sintering to obtain a consolidated ceramics plate. 0.307 g of nitride red phosphor aforementioned was compacted in graphite die with an inner diameter of 13 mm and a wall thickness of 50 mm. The powder was separated by graphite spacer made of graphite foil of about 0.5 mm in thickness. The compact nitride red phosphor powder was consolidated at 1400° C. for about 10 min at 40 MPa by following the same temperature and pressure profiles as that in EXAMPLE (1).

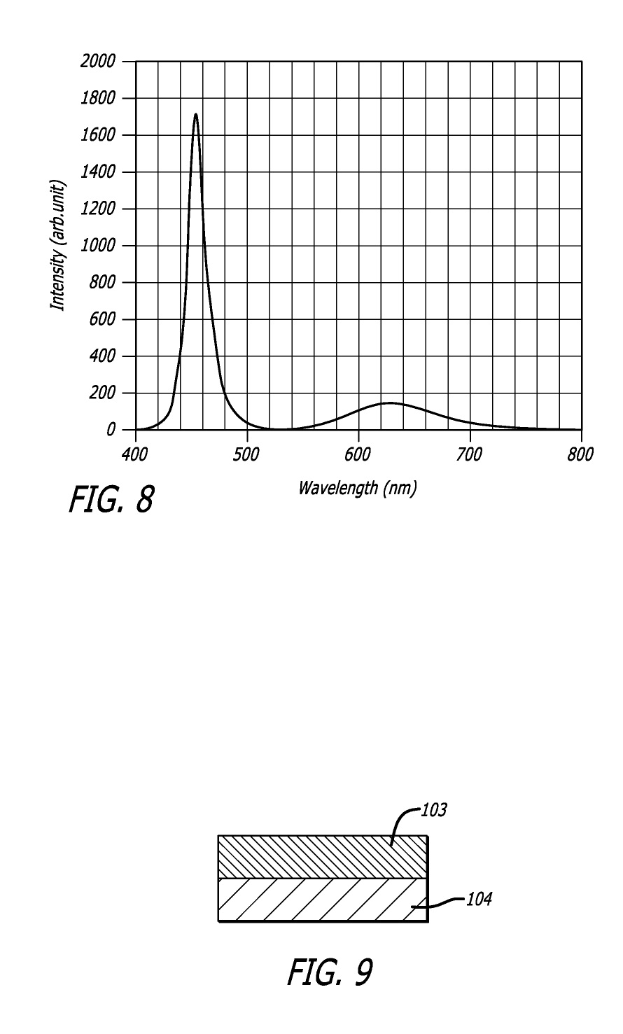

PL spectra (FIG. 8) of the consolidated nitride ceramics was measured by using the same optic setup and procedures as that in EXAMPLE (1), which showed a existence of emission spectra similar to that of powders before SPS sintering.

### Example 3

### Co-firing of YAG:Ce³⁺ and Red Nitride Phosphor

Integration of YAG:Ce phosphor ceramics 103 with nitride red phosphor 104 (FIG. 9) is carried out by using SPS sintering. YAG:Ce³⁺ ceramics are prepared by laminating green sheets by tape casting, which comprises Al₂O₃ and Y₂O₃ precursors at the stoichiometric ratio of YAG (Y₃Al₅O₁₂), organic polymer binder and plasticizer, TEOS corresponding to 0.5 wt % of SiO₂ as sintering aid, and 0.4 at % of Ce with respect to Yttrium content as an activator for photoluminescence. CaAlSiN₃:Eu²⁺ ceramics are prepared by laminating green sheets by tape casting, which are composed of CaAlSiN₃:Eu²⁺, organic polymer binder and plasticizer, 5.0 wt % of Y₂O₃ as sintering aid. The laminates with a thickness of 540 μm (YAG:Ce) and about 200 μm is cut into a circular shape with a diameter of 13 mm and will be heated up to 1200° C. and held for 2 hrs at a heating rate of 2° C./min to burn out the organic constituent and get partially consolidated.

A second sintering is carried out in SPS Dr Sinter 511S under a vacuum around 10⁻² Torr at heating rate of about 100° C./min from room temperature to about 1400° C., holding at 1400° C. for 10 min at 40 MPa applied at the beginning of the heating, pressure release after holding the material at 1400° C. for 10 min. It is anticipated that a laminate of YAG:Ce³⁺ and CaAlSiN₃:Eu²⁺ will result.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

The terms “a,” “an,” “the” and similar referents used in the context of describing the invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of any claim. No language in the specification should be construed as indicating any non-claimed element essential to the practice of the invention.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A method of preparing a dense phosphor ceramic, comprising:
heating a multi-elemental composition to sinter the composition by applying a pulse electric current to the composition at a pressure of about 1 MPa to about 500 MPa, wherein the multi-elemental composition comprises:
a garnet or a garnet precursor; and
a nitride or a nitride precursor;
wherein the method produces a dense phosphor ceramic.

2. The method of claim 1, wherein a pulse of the pulse electric current has a maximum current of about 250 A to about 2000 A.

3. The method of claim 1, wherein the multi-elemental composition is heated to a temperature of about 1000° C. to about 1800° C.

4. The method of claim 1, wherein applying the pulse electric current causes a temperature rise of the multi-elemental composition at a rate of about 10° C./min to about 600° C./min.

5. The method of claim 1, wherein the multi-elemental composition comprises the garnet precursor, and wherein the garnet precursor comprises an oxide of yttrium, an oxide of aluminum, an oxide of gadolinium, an oxide of lutetium, an oxide of gallium, or an oxide of terbium

6. The method of claim 1, wherein the garnet is a powder.

7. The method of claim 1, wherein the nitride precursor comprises Ca₃N₂, AlN, Si₃N₄, or a combination thereof.

8. The method of claim 1, wherein the multi-elemental composition further comprises a dopant or a dopant precursor.

9. The method of claim 1, wherein the multi-elemental composition is heated in contact with a sintered ceramic plate.

10. The method of claim 1, wherein the multi-elemental composition comprises the garnet and the nitride, and wherein the garnet is a powder and the nitride is a powder.

11. The method of claim 1, wherein the dense phosphor ceramic has a density of at least 70% as compared to a solid ceramic of the same composition having no voids.

12. The method of claim 1, wherein the dense phosphor ceramic comprises a garnet having a formula (Y₁₋ₓCeₓ)₃Al₅O₁₂, or a garnet precursor thereof, wherein x is about 0 to about 0.05.

13. The method of claim 1, wherein the dense phosphor ceramic comprises CaAlSiN₃:Eu²⁺, or a nitride precursor thereof, wherein the Eu²⁺ is about 0.001 atom % to about 5 atom %, based upon the number of calcium atoms.

14. A dense phosphor ceramic prepared according to the method of claim 1, wherein the dense phosphor ceramic comprises a sintered plate.

15. The dense phosphor ceramic of claim 14, comprising a plurality of sintered plates laminated to each other.

16. A ceramic compact comprising a first layer comprising garnet material and a second layer comprising a nitride material.

17. The compact of claim 16, wherein the garnet material is a yttrium garnet.

18. The compact of claim 16, wherein the nitride material is CaAlSiN₃.

19. The compact of claim 16, having an average grain diameter of about 0.1 μm to about 20 μm.

20-34. (canceled)
